(19) United States
(12) Patent Application Publication
(10) Pub. No.: US 2022/0277080 A1
(43) Pub. Date: Sep. 1, 2022

(54) METHOD AND SYSTEM FOR AUTOMATICALLY CHECKING NON-COMPLIANCE OF DEVICE FIRMWARE

(71) Applicant: IoT Inspector R&D GmbH, Wiener Neustadt (AT)

(72) Inventors: Michael Schmid, Bad Homburg (DE); Florian Lukavsky, WIENER NEUSTADT (AT); Marton Illes, WIENER NEUSTADT (AT); Rainer Richter, WIENER NEUSTADT (AT)

(21) Appl. No.: 17/186,297

(22) Filed: Feb. 26, 2021

(51) Int. Cl. G06F 21/57

(52) U.S. Cl. CPC G06F 21/572; G06F 2221/033; G16Y 40/20

(57) ABSTRACT

A system and computer implemented method for automatically checking non-compliance of device firmware (30) is disclosed. The method comprises receiving (200) an image (50) of the device firmware (30) to a pipeline (40) and accessing (225) at least one requirement (125) from a guidelines database (120). The guidelines database (120) comprises a plurality of guideline documents (310) and common requirements (340), wherein the common requirements (340) are common to a plurality of the guideline documents (310). At least detection rule (140) on the downloaded device firmware (30) is run (230) to detect a violated one of the at least one requirement (125) in the device firmware (30) and the violated requirement is flagged (225) in a compliance database (135).

### CROSS-REFERENCE TO RELATED APPLICATIONS

None

### BACKGROUND OF THE INVENTION

### Field of the Invention

The invention relates to a computer-implemented method and a system for automatically checking non-compliance of firmware in an IoT (Internet of Things) device.

### Brief Description of the Related Art

With the growth of the global Internet of Things (IoT) device market, the number of IoT devices has increased dramatically with a recent report suggesting that there will be 41 billion IoT devices by 2027, up from around 8 billion in 2019 (accessed at https://www.businessinsider.com/internet-of-things-report?r=DE&IR=T on 24 Feb. 2020). The purpose of these IoT devices is to collect information using embedded sensors or other technologies and to connect and exchange information with other IoT devices and processors over the Internet and through a local intranet.

The manufacturers of the IoT devices often rely on third-party software and hardware components to speed up development processes. In addition to the own code base, these third-party software and hardware components may potentially contain critical security vulnerabilities and the third-party software and hardware components need to be tested, both for publicly known vulnerabilities and other identified vulnerabilities. The increasing amount of competition in the IoT device market means that manufacturers of the IoT devices often shorten their release cycles and release those IoT devices without extensive security testing. The increasing use of IoT devices in private homes, which are connected to the Internet has also become a growing concern because of data privacy and security issues.

This problem has been recognized and non-governmental organizations, standards setting organizations, industry trade organizations, and governments have released “best practice recommendations” and legal standards to promote and enforce the practice of releasing well-tested, secure IoT devices. There are, however, a number of these recommendations and standards against which the newly released IoT devices need to be certified compliant and this in turn has become an issue due to the large amount of time and resources required to test against the different types of standards.

The types of standards for which the IoT devices need to be made compliant depend very much on the technology and also the country or region in which the IoT device will be used. For example, an IoT device used in the United States must be authorized for use by the Federal Communications Commission. Many other countries, including the European Union and the United Kingdom have similar national or regional requirements. Any IoT devices made in one country and exported into another country will often need to be compliant with the standards and requirements of both of the countries. This will require two or more sets of testing against a number of different standards, guidelines and other best practice recommendations. The term “guidelines” will be used in this document as a generic definition to encompass all these terms.

In practice, although the wording in the documents for the guidelines may differ, there are many common elements between the different guidelines. Currently, testing against the different guidelines often involves repeating tests. It is possible that a testing institute recognizes the similar tests and is able to re-use previously carried out tests (or parts of the tests) in order to certify a device is compliant. There is no system known in the art in which there is a systematic test of compliance including re-use of existing data.

### Prior Art

Various patent applications are known, which enable checking of the compliance of the IoT devices and networks of the IoT devices to comply with the guidelines. For example, U.S. Pat. No. 10,652,278 B2 (assigned to Forescout Tech) teaches a system and method for monitoring the compliance of networks of the IoT devices by detecting a (new) IoT device coupled to the network and then determining a classification of the newly connected IoT device based on traffic information associated with the IoT device. A corresponding compliance rule based on the classification of the IoT device is determined and a compliance scan is performed on the IoT device based on the compliance rule. The result of the compliance scan determines a compliance level of the device based on a result of the compliance scan of the device and enables the performance of an action based on the compliance level.

This patent discloses a system and method in which the compliance is carried out on the IoT devices from the “outside” to see whether the newly connected IoT devices are compliant in the IoT network. There is no review of the firmware of the IoT devices, i.e., no looking at the IoT devices from the “inside”. The system and method enable the discovery of new IoT devices added to the IoT network and uses automated of scanning of the IoT devices to devise automated mitigating strategies if required.

US 2018/0121931 A1 (assigned to IBM) teaches a method for ensuring compliance of the IoT devices in the IoT network by providing one or more solutions for the IoT devices identified as having performance obligation deficiencies according to a knowledge domain that describes the performance obligations for the plurality of sensor-based devices. The method disclosed in this patent application focusses on checking the compliance of the IoT devices regarding performance requirements, but not on compliance with the security requirements of the IoT devices.

U.S. Pat. No. 10,805,165 B2 (Afero) teaches a system and method for managing attributes in the IoT network and determining whether the attributes correspond to pre-defined constraints. The system of this patent performs the operations of specifying a plurality of attributes for a corresponding plurality of items of data managed in the IoT device and/or an IoT service, associating one or more ancillary attributes with one or more of the plurality of attributes wherein the ancillary attributes specify attribute configurations and/or interdependencies between one or more of the plurality of attributes. The ancillary attributes are evaluated to ensure compliance with predefined constraints associated with the plurality of items of data and an indication of compliance is generated if the one or more ancillary attributes are in compliance with the predefined constraints.

This prior art fails, however, to show a system in which the firmware of the IoT device is reviewed for compliance with a plurality of security guidelines.

On the other hand, U.S. Pat. No. 10,534,918 B1 (Davidi et al, assigned to VDOO) teaches a method, apparatus and verification which acknowledges the need to review the firmware of the device for compliance with certification or validation requirements, such as security requirements and is not subject to security breaches. The patent states that the standards' requirements may be “mapped” to the vulnerabilities and the components of the firmware but fails to teach a method by which this mapping is carried out. The patent does not teach a method for identifying the vulnerabilities but accesses a vulnerability database in which CVE (common vulnerability and exposure) records are stored.

Tien et al “UFO—Hidden Backdoor Discovery and Security Verification in IoT Device Firmware”, 2018 IEEE International Symposium on Software Reliability Engineering Workshops, pages 18-23 (DOI:10.1109/ISSREW.2018.00-37) also addressed the requirement to verify that the firmware of an IoT device was tested according to various IoT security standards and listed three standards as examples. The UFO program outlined in this Tien et al paper described the use of scripts to facilitate the checking of the firmware but did not describe a method of generally monitoring the compliance of an IoT device with the known standards.

### SUMMARY OF THE INVENTION

This document teaches a computer-implemented method for automatically checking non-compliance of device firmware with one or more standards, laws, regulations or guidelines. The method comprises receiving an image of the device firmware to a pipeline, accessing at least one requirement from a guidelines database, and running at least one detection rule on the downloaded device firmware to detect a violated of at least one requirement in the device firmware. Information about a violated requirement is stored in in a compliance database and can be presented as compliance information to a user through an interface.

The method enables an automated checking of the device firmware against a number of guidelines, which are stored in the guidelines database without manual intervention. In one aspect of the method, the guidelines database comprises a plurality of guideline documents representing standards and best practices. Some of the plurality of the guidelines have common requirements and the method enables the review of the compliance of the common requirements to be carried out once and the results of the review to be re-used when checking the compliance with several of the guidelines, i.e., there is no need to carry out the same multiple reviews. This reduces the resources required to carry out the review of the compliance. The review can be carried out more efficiently and less data needs to be stored.

The compliance check is, in one aspect, limited to review of security requirements.

A compliance checking system for automatically checking compliance of device firmware is also disclosed. The compliance checking system comprises a pipeline for storing a plurality of firmware images from a plurality of IoT devices, and a guidelines database for storing a plurality of guideline documents with a plurality of detection rules. A processor is used to access a compliance database with compliance results from a compliance review carried out on the firmware by an external module. The compliance database comprises the compliance results from a compliance analysis engine adapted to run at least one of the plurality of detection rules on at least one of the plurality of images.

The use of the compliance checking system separate from the compliance analysis engine enables different types of compliance analysis engines to be used.

The compliance checking system further comprises a user terminal with a display device for displaying violated ones of a requirement detected by the compliance analysis engine.

### DESCRIPTION OF THE DRAWINGS

For a more complete understanding of the present invention and the advantages thereof, reference is now made to the following description and the accompanying drawings, in which:

FIG. 1 shows an example of the compliance checking system of the current document.

FIG. 2 shows the method of automatically check the compliance of an IoT device using the compliance checking system.

FIG. 3 shows the structure of the guidelines database.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

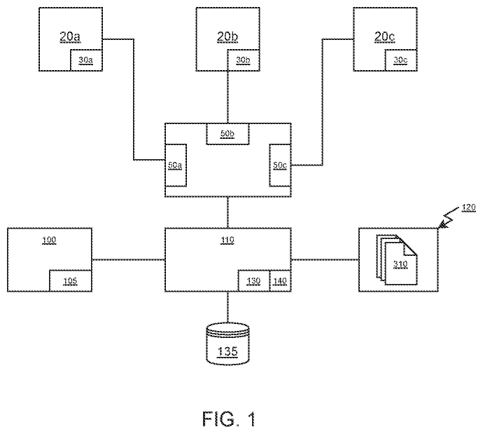

FIG. 1 shows a non-limiting example of a compliance checking system 10 for automatically checking non-compliance of device firmware 30a-c, which is stored in a plurality of IoT devices 20a-c. Three of the IoT devices 20a-c are shown in FIG. 1, but it will be appreciated that this is not limiting of the invention and that there will be many more IoT devices 20a-c, which need to be checked for non-compliance with a plurality of compliance standards. The IoT devices 20a-c are unlikely to be of the same design and may have different hardware and software components. The IoT devices 20a-c will also generally perform different functions. Non-limiting examples of the IoT devices 20a-c include but are not limited to temperature sensors, humidity sensors, vibration sensors, CCTV cameras, industrial control systems, and smart health devices. The IoT devices 20a-c have in common that the IoT devices 20a-c include software to operate the IoT devices 20a-c, which is embedded in device firmware 30a-c.

The device firmware 30a-c is stored in a storage medium on the IoT device 20a-c and controls the operation of the hardware in the IoT device 20a-c. The storage medium used in the IoT device 20a-c for the device firmware 30a-c is usually a non-volatile memory, such as but not limited to extended flash memory, which retains the code of the device firmware 30a-c even without power. Volatile memory can also be present to store data and some code temporarily.

To test the compliance or rather the non-compliance of the firmware in the IoT device 20a-c, the firmware 30a-c needs to be checked for compliance. This is done by using a processor 110 running a compliance analysis engine 130. The compliance analysis engine 130 is adapted to run at least one of a plurality of detection rules 140 on an image 50a-c of the device firmware 30a-c of the IoT devices 20a-c. One non-limiting example of the compliance analysis engine 130 are the tools provided by IoT Inspector GmbH, Bad Homburg, Germany through their website www.iot-inspector.com. A compliance database 135 includes details of common vulnerabilities and exposures (CVE) extracted from, for example, the US national vulnerability database (NVD) run by the NIST in the United States and may also include additional vulnerabilities and exposures identified but not (yet) recorded in the NVD. Such additional vulnerabilities and exposures include, but are not limited, to encryption issues when communicating with a back end, insecure communications over an insecure channel, problems with certificates and configuration errors. The compliance database 135 should be updated regularly from public sources. A severity score is attached to the vulnerabilities and exposures in the compliance database.

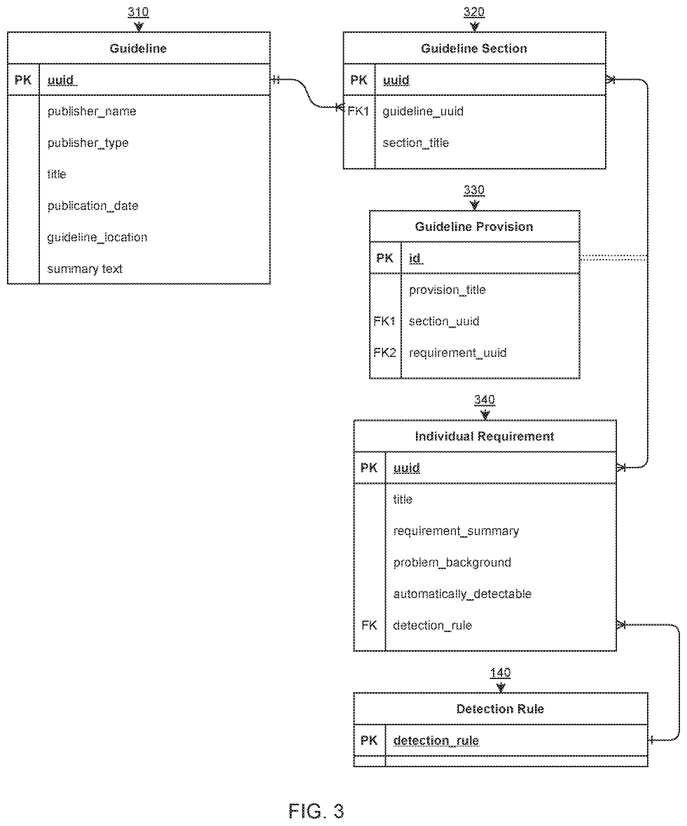

There are a plurality of scripts in the compliance engine 130 for the detection rules 140. The scripts of the detection rules 140 test for one or more of the common vulnerabilities and exposures. Generally similar classes comprising several vulnerabilities and exposures (from the compliance database 135) are tested using one script. The detection rules 150 are matched to the requirements set out in a plurality of guideline documents 310 stored in a guideline database 120 and the generation of the detection rules 140 will be described with respect to FIG. 3. The results of the compliance engine 130 are stored in a compliance database 135.

The images of the device firmware 30a-c are placed into a pipeline 40 where the images are stored for later access by the compliance analysis engine 130 in the processor 110. The images of the device firmware 30a-c can be received directly from the vendor of the IoT device 20a-c, for example from a website, or the images can be received by downloading them from the IoT device 20a.

A user terminal 100 with a display 105 is connected to the processor 110 and is used to control the compliance checking system. The user terminal 100 includes a display 105 for displaying the results of the compliance analysis engine 130. For example, the display device 105 is able to display information about a requirement in the compliance standards, which was detected as being violated by one or more of the detection rules 140.

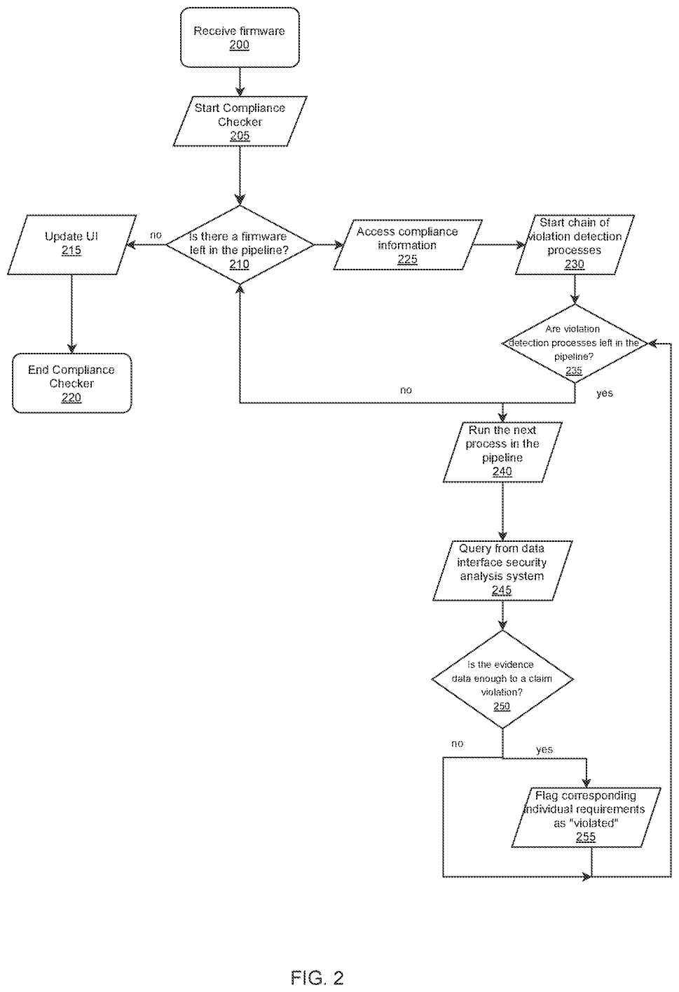

FIG. 2 shows an outline of the method used to check compliance automatically of the device firmware 30a-c. An image of the device firmware 30a-c is received in step 200 to the pipeline 40 and in step 205 the compliance analysis engine 130 is initiated. A check is carried out in step 210 to see whether there is more device firmware 30a-c for testing left in the pipeline 40. The method moves in step 225 to access the compliance information against which of the device firmware 30a-c needs to be checked for non-compliance. In one aspect, all of the compliance information is checked that is obtained from the guideline documents 130 and in the compliance database 135. This access in step 225 requires accessing the guidelines database 120 with the detection rules 140. The relevant detection rules 140 are run in one aspect in the compliance analysis engine 130. In another aspect, the compliance analysis engine 130 runs all of the possible detection rules 140 but presents to the user only the results required.

In step 235 a decision is made whether there are any further detection rules 140 to be run in the compliance analysis engine 130 on the image of the device firmware 30a-c. If this test indicates that further detection rules 140 should be run, the method proceeds to the next step 240 in which case the detection rule 140 is run in the compliance analysis engine 130. The compliance analysis engine 130 fetches any data that is required in step 245. In one aspect, a test dataset could be stored in a memory in the processor 110 for testing the IoT device. Once the detection rule 140 is run in the compliance analysis engine 130, then a test is made in step 250 to see if the data, such as that in the test dataset, is sufficient to provide the evidence that is required to determine non-compliance with the guideline. If this non-compliance is the case, then a flag can be set in step 255 and stored in the compliance database 135 to indicate that the device firmware 30a-c is non-compliant with the degree of severity indicated by the severity score stored in the compliance database 135 and that a violation has been noted.

It is possible that the test in step 250 determines that the evidence of non-compliance is not yet established and that further detection rules 140 need to be run and the loop then restarts in step 235. On the other hand, if there are no more detection rules 140 to be carried out and no more images left in the pipeline 40, then the test in step 210 updates the violation information in the user interface, which can be displayed on the display 105 as well as being stored in memory for later access.

The user can infer that the device firmware 30a-c is compliant for the detection rules 140 tested based on accessing the compliance database 135 with the results and/or indicate areas in which the device firmware 30a-c is not compliant. In further aspects of the invention, the user may also receive details of the problems identified and, if possible, a report as to the remedial actions that the firmware developer can undertake. Details of the remedial actions are accessed from a database.

FIG. 3 shows an example of the structure in the guidelines database 120. The guidelines database 120 is implemented in one aspect of the invention using a relational database management system. A non-limiting example would be an open-source database, such as the PostgreSQL database.

The guidelines database 120 has a four-level structure. The topmost level (level 4) is a plurality of guideline documents 310 with the details of the guidelines. These guidelines documents 310 are structured into a plurality of guideline sections 310 forming the next level (level 3). The guideline documents 310 are in turn sub-divided into a number of individual requirements 340, which form level 2. As noted above, the individual requirements 340 are broken out such that the individual requirements 340 are common to one or more of the guidelines. In other words, it is possible for the guideline sections 320 to be different for different ones of the guideline documents 310, but there is a core of common individual requirements 340 as will be explained later.

A table 330 matches the individual requirements 340 to the requirements set out in the guideline sections 320. The table 330 will have a many-to-many structure in which a plurality of the individual requirements 340 may be matched to one or more of the guideline sections 320. It was noted above that similar or identical individual requirements 340 are found in different ones of the guidelines and thus the table 330 will not just refer to different guideline sections 320 in a single one of the guideline documents 310 but may also refer to different guideline sections 320 in different ones of the guideline documents 310. One example of a similar or identical requirement would be the requirement that default passwords, usernames, or other credentials should not be stored in the IoT devices 20a-c. This requirement of “no hardcoded credentials” is designed to ensure that a hacker cannot access the IoT devices 20a-c to obtain the credentials and then use the hacked credentials to obtain access, for example, to an interface in which the IoT devices 20a-c store data. This individual requirement is expressed differently in different ones of the guidelines, e.g., using terms such as “no hardcoded credentials”, “user credentials shall not be hardcoded into the system”, “no storage of usernames and passwords”, etc. In each of these cases, the technical effect is identical and thus the test for (non-)compliance is identical and can be expressed as a single individual requirement with an identical detection rule 140.

One or more detection rules 140 form the level 1 and level 2 are established for the individual requirements 340. In the example shown in FIG. 3, only one detection rule 140 is shown for one of the individual requirements, but it is possible that more than one detection rule 140 is required to fully test for compliance violations of the individual requirements 340.

FIG. 3 also shows examples of the fields of information stored in the guidelines database 120. The guidelines 310 include the name of the publisher, (publisher_name) such as the aforementioned US FCC, the IEEE, the European Commission, other standard setting organizations (SSO), and the type of publisher (publisher_type). The type of the publisher could be “legal requirement” for those guidelines, which have the force of law or “recommendation” for guidelines, which represent best practice. The guideline document 310 has a title (title_char), a publication date (publication_date) as well as a detail of the location of the current or historic text of the guideline, such as the URL or DOI, (guidelines_location). Finally, there may be a textual summary of the guideline to enable the user to understand what is being checked. The guideline section 320 includes a reference to the guidelines 310 of which it is part (guideline_uuid) and the title of the guideline section (title_char).

The individual requirements 340 include a title (title_char) with a summary of the requirement in text form (requirement_summary) and an explanation of the problem for which the individual requirement tests (problem_background). There are some individual requirements 340 that cannot be detected automatically, and these are indicated in the field “automatically_detectable”. Finally, there is a reference (detection_rule) to the name of the detection rule 140, which tests for violations of individual requirements.

An example can illustrate these individual requirements in more detail. This example is outlined above and is taken from the ETSI EN 303 645 standard, provision 5.4-3, on page 19 and is related to the restriction that hard-coded critical security parameters in device software should not be used in IoT devices as reverse engineering of the IoT devices could easily enable discovery of credentials such as hard-coded usernames and passwords. A copy of this standard in 2020-06 version 2.2.1 is available at this link: https://www.etsi.org/deliver/etsi_en/303600_303699/303645/02.01.01_60/en_303645v0 20101p.pdf (downloaded 24 Feb. 2021). This European standard relates to cyber security for consumer internet of things.

Another example of an individual requirement is set out in provision 5-13-1 on page 24 of the ESTI EN 303 645 standard, which relates to the validation of data input. There are two individual requirements 340 that are listed in this provision:

Example 1: the IoT device 20a-c receives data that is not of the expected type.

Example 2: the IoT device 20a-c receives out of range data (e.g., temperature too high)

Two detection rules 140 can be run on data input to detect this. In a first detection rule 140-1 data from the test data set would be passed to the compliance analysis engine 130. The test data set would be data, which is of the expected type and data, which is not of the expected type. The compliance analysis engine 130 should give an indication of a violation in step 225 if the incorrectly formatted data is input to the firmware 30a-c and should give an indication of no violation if the correctly formatted data is input to the firmware 30a-c. The compliance analysis engine 130 has a simple test incorporated in this example.

There are numerous further compliance rules that need to be detection and examples of the guidelines include, but are not limited to the following:
OWASP IoT TOP 10 (see link: https://wiki.owasp.org/index.php/OWASP_Internet_of_Things_Project#tab=IoT_Top_10)
BITAG Internet of Things (IoT) Security and Privacy Recommendations
   https://www.bitag.org/report-internet-of-things-security-privacy-recommendations.php
ENISA Baseline Security Recommendation for IoT
   https://www.enisa.europa.eu/publications/baseline-security-recommendations-for-iot
DIN SPEC 27072—https://www.beuth.de/en/technical-rule/din-spec-27072/303463577
UK GOV Consumer IoT
   https://assets.publishing.service.gov.uk/government/uploads/system/uploads/attachment_data/file/773867/Code_of_Practice_for_Consumer_IoT_Security_October_2018.pdf

Non-limiting examples of the compliance detection rules from the various guidelines are set out in the following table:

| | Compliance Checker | |
|---|---|---|
| | has been fed by 245 | |
| | (the interface to a | |
| | vulnerability | |
| | checking system) | |
| | with following | |
| Detection Rule | evidence data: | Matching Provisions |
| INPUT_ | Presence of | OWASP loT Top 10— |
| VALIDATION | Software | “Insecure Ecosystem |
| | Components in the | Interfaces” |
| | firmware that | |
| | enable Input | |
| | Validation Attacks | |
| NO_CVES | Presence of | OWASP loT Top 10— |
| | Software | “Use of Insecure or Outdated |
| | Components in the | Components″ |
| | firmware with | |
| | known CVEs | |
| | (common | |
| | vulnerabilities and | |
| | exposures) | |
| USES_COMPILE_ | Presence of ELF | ETSI EN 303 645— |
| TIME_ | binaries in the | “Provision 5.6-7” |
| MITIGATION_ | firmware with | |
| TECHNIQUES | no hardening | |
| | techniques | |
| NO_DEFAULT_ | Presence of | DIN SPEC 27072— |
| CREDENTIALS | hardcoded | “loTD.ChangeStdPw” |
| | credentials in the | |
| | firmware which | |
| | correspond to the | |
| | pre-set by the | |
| | manufacturer | |
| NO_EMPTY_ | Presence of user | ENISA Baseline Security |
| PASSWORDS | accounts on in the | Recommendations— |
| | firmware which | “GP-TM-24” |
| | require no password | |
| | to authenticate | |
| NO_HARDCODED_ | Presence of | UK.GOV Code of Practice for |
| CREDENTIALS | hardcoded | consumer loT security—“4. |
| | credentials in the | Securely store credentials and |
| | firmware | security-sensitive data″ |
| NO_INSECURE_ | Presence of ELF | ETSI EN 303 645— |
| FUNCTIONS | binaries in the | “Provision 5.6-9” |
| | firmware which | |
| | make use of known | |
| | insecure functions | |
| NO_OPENSSL_ | Presence of the an | ENISA Baseline Security |
| CVE | outdated version of | Recommendations— |
| | the component | “GP-TM-39” |
| | “open-ssl” in the | |
| | firmware | |
| NO_PRIVATE_ | Presence of | BITAG Internet of Things |
| KEYS | hardcoded private | (loT) Security and Privacy |
| | cryptographic key | Recommendations “Encrypt |
| | in the firmware | Local Storage of Sensitive |
| | | Data” |
| NO_TELNET | Presence of | OWASP loT Top 10— |
| | component “telnet” | “Insecure Data |
| | in the firmware | Transfer and Storage” |

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto and their equivalents. The entirety of each of the aforementioned documents is incorporated by reference herein.

### REFERENCE NUMERALS

10 Compliance Checking System

20a-c IoT devices

30a-c Device firmware

40 Pipeline

50a-c Image

100 User terminal

105 Display

110 Processor

120 Guidelines database

125 Requirement

130 Compliance analysis engine

135 Compliance database

140 Detection rule

What is claimed is:

1. A computer implemented method for automatically checking non-compliance of device firmware comprising:
receiving an image of the device firmware to a pipeline;
accessing at least one requirement from a guidelines database, wherein the guidelines database comprises a plurality of guideline documents and common requirements and wherein the common requirements are common to a plurality of the guideline documents;
running at least one detection rule on the downloaded device firmware to detect a violated one of the at least one requirement in the device firmware; and
flagging the violated requirement in a compliance database.

2. The method of claim 1 further comprising access the compliance database and providing compliance information to user.

3. The method of claim 1, wherein the at least requirement is a security requirement.

4. A compliance checking system for automatically checking compliance of device firmware comprising:
a pipeline for storing a plurality of images from a plurality of Internet of Things devices;
a guidelines database for storing a plurality of guideline documents with a plurality of detection rules, wherein the guidelines database comprises a plurality of guideline documents and common requirements, wherein the common requirements are common to a plurality of the guideline documents;
a processor accessing a compliance database, the compliance database comprising compliance results from a compliance analysis engine adapted to run at least one of the plurality of detection rules on at least one of the plurality of images.

5. The compliance checking system of claim 4, further comprising a user terminal with a display device for displaying a violated one of a requirement detected by the compliance analysis engine.

6. The compliance checking system of claim 4, wherein the plurality of detection rules in the guidelines database are adapted to detect common requirement between the different ones of the guideline documents.

7. The compliance checking system of claim 4, wherein the compliance results are security compliance results.
